(19) United States
(12) Patent Application Publication
(10) Pub. No.: US 2006/0051207 A1
(43) Pub. Date: Mar. 9, 2006

(54) Light emitting diode array mounted within windmill wing tip

(76) Inventors: Steven R. Becerra, San Pedro, CA (US); Lei U. Vinoya, Long Beach, CA (US); Robin P. Altena, Torrance, CA (US)

Correspondence Address: Irving Keschner, Suite 1150, 21515 Hawthorne Boulevard, Torrance, CA, 90503, US

(21) Appl. No.: 10/934,245

(22) Filed: Sep. 3, 2004

(51) Int. Cl. F03D 11/00

(52) U.S. Cl. 416/5

(57) ABSTRACT

Arrays of LEDs are mounted within the tip of windmill wings, each array comprising a plurality of LEDs mounted to printed circuit boards. Additional printed circuit boards assembled over the LED printed circuit boards provide both a radio frequency interference barrier and Faraday cage effect lightning protector. This assembly (lamination) forms assembled core units which then slide into dove tails formed in a central bracket positioned in the wing interior. The bracket also serves as a wing tip spar. The spar, with the assembled core units coupled thereto, slides into channels formed in the interior surfaces of the wing.

### BACKGROUND OF THE MENTION

1. Field of the Invention

The present invention provides an improved windmill wing wherein a light emitting diode array is mounted in the wing tip.

2. Description of the Prior Art

Windmills having wings, or blades, that are utilized to harness the energy of the wind have been commercially available for many years. Improvements to various components of the windmill such as the blades, hub, generator and gearbox have been made over the years. For example, U.S. Pat. No. 6,457,943 to Olsen et al discloses a wind turbine blade having an improved lightning conductor comprising carbon fiber reinforced plastic oblong strips formed as part of the blade itself.

Some modern day windmills are extremely tall, particularly those utilized in Denmark, wherein the heights of 120 meters are not unusual. Since a windmill structure of this height has the capability of interfering with low flying aircraft, an attempt has been made to place warning lights on appropriate places on the windmill base and on the wings themselves, the light generated thereby not being sufficient to meet safety concerns. The current use of lighting on the blade tips similarly does not produce light of sufficient intensity or focusing ability to provide an adequate warning alert (a red stripe has also been painted on the wing edge to provide an alert) since the current size of windmills do not violate international space and, as a result, did not require specific alert standards for the windmills. However, the increased demand for greater electrical power will require windmills of a size that will violate international air space.

What is desired therefore is to provide an improved windmill warning light contained within the wing tip having sufficient intensity and focusing capability to act as a light beam so that an easily visible warning signal is provided to approaching aircraft.

### SUMMARY OF THE INVENTION

The present invention provides a light emitting diode (hereinafter “LED”) array that is mounted in the tip of a windmill wing, or blade, that provides a high intensity light beam that is focused into a desired angular range such that approaching aircraft have a visible indication while at a safe distance from the windmill.

In particular, arrays of LEDs are mounted within the tips of windmill wings, each array comprising a plurality of LEDs mounted to printed circuit boards. Additional printed circuit boards assembled over the LED printed circuit boards forming core units which provide both a radio frequency interface (“RFI”) barrier and Faraday cage effect lightning protector and forms assembled core units. The core units are mounted to a framework, or mounting structure, the framework then sliding into dove tails formed in a central bracket, or holding structure, positioned in the wing interior. This bracket is the spar of the wingtip, and with the assembled core units coupled thereto, slides into channels formed in the interior surface of the wing.

The spar is tapered along its length so that it fits within the wing and the LEDs are electronically coupled to a central unit to produce a controlled light burst so that the desired light intensity is attained. In a preferred embodiment, eighteen arrays, each array having one hundred twenty (120) LEDs, are utilized to provide the desired lighting pattern.

The present invention thus provides a windmill having a plurality of wings, an array of LED bulbs or lamps being positioned within the wing tip. Using LEDs provides a focused, high intensity illumination source that is solid state, thus providing a long life, a low power demand, reduced maintenance requirements and energy costs unlike other light sources currently utilized in the industry. In addition, the array configuration of the present invention enables the original wing airfoil shape to be maintained.

### DESCRIPTION OF THE DRAWINGS

For a better understanding of the present invention as well as other objects and further features thereof, reference is made to the following description which is to be read in conjunction with the accompanying drawing therein:

FIG. 1 is a partial perspective view of a windmill utilizing the LED array of the present invention;

FIG. 2 is a detail of the windmill wing tip;

FIG. 3 is a cross-sectional view along line 3-3 of FIG. 2;

FIG. 4 is a cross-sectional view along line 44 of FIG. 2;

FIG. 5 is a cross-sectional view along line 5-5 of FIG. 3;

FIG. 6 illustrates a LED array positioned in the mounting structure within the windmill wing;

FIG. 7 illustrates how the LED array shown in FIG. 6 is mounted to the mounting structure within windmill wing;

FIG. 8 is the core structure utilized to mount the LED array to the wing;

FIG. 9 is an enlargement of FIG. 3 and illustrates the light pattern emitted by the array of LEDs; and

FIG. 10 is a block diagram of the LED array control circuit.

### DESCRIPTION OF THE INVENTION

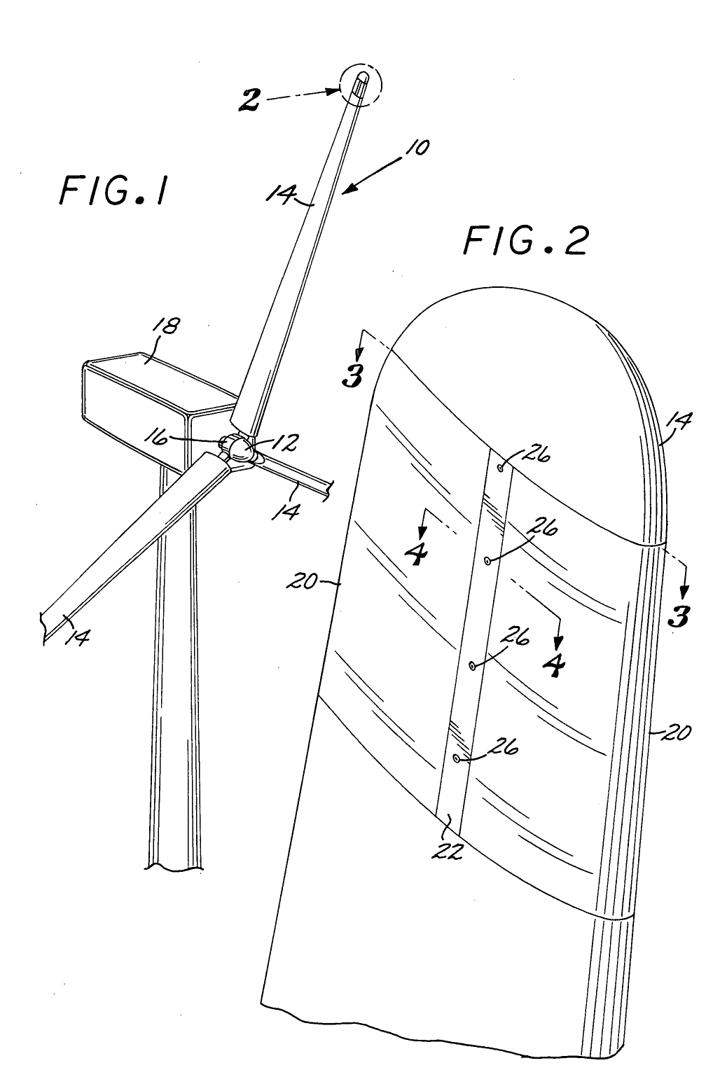

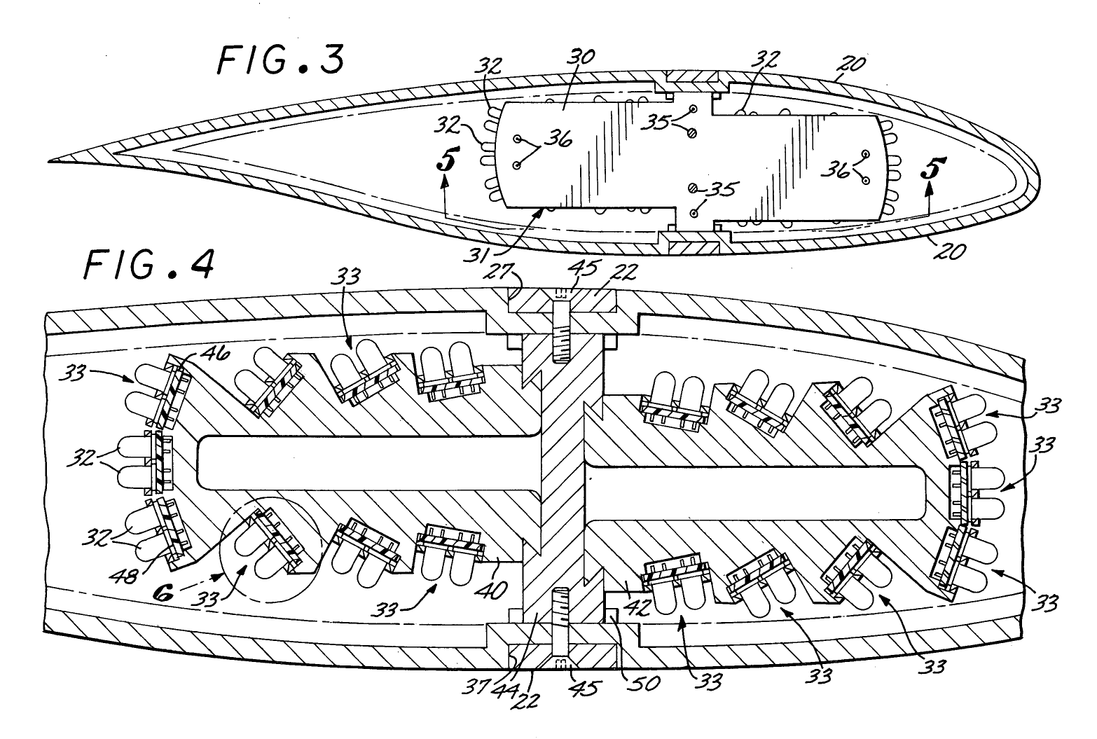

Referring now to FIGS. 1 and 2, a simplified perspective view of a windmill 10 modified to incorporate the teachings of the present invention is illustrated. Windmill 10 comprises hub 12, three wings, or blades 14, shaft 16 and housed generator assembly 18. A detail of the tip of a wing 14 is illustrated in FIG. 2 and shows two transparent covers 20 mated with vertical structural supports, or bars, 22 by fastening members 26.

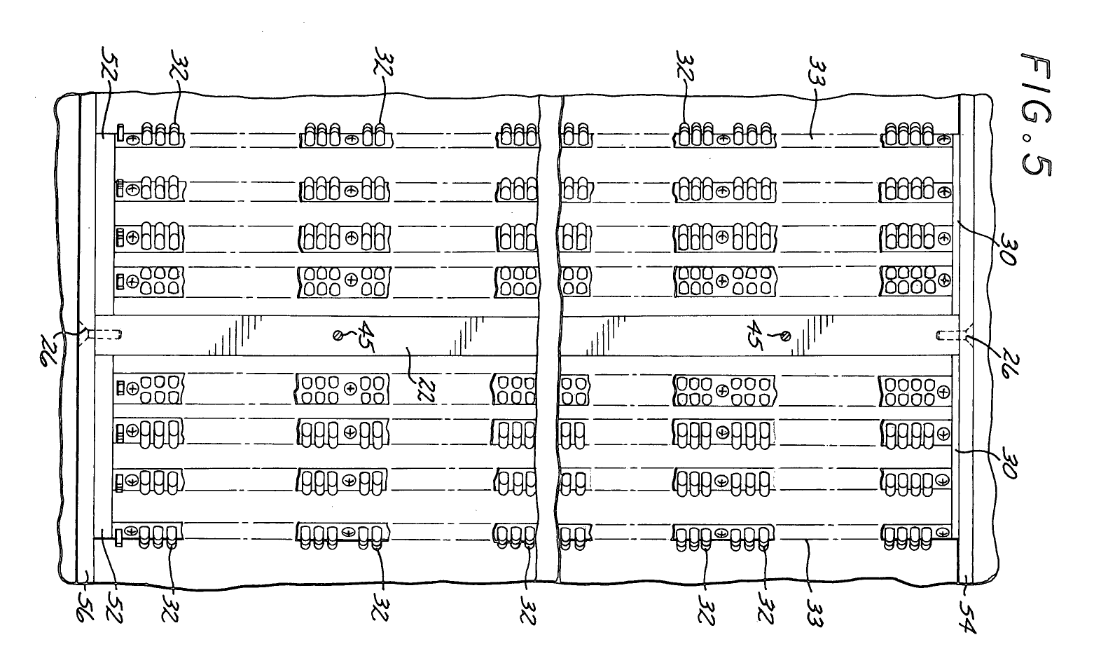

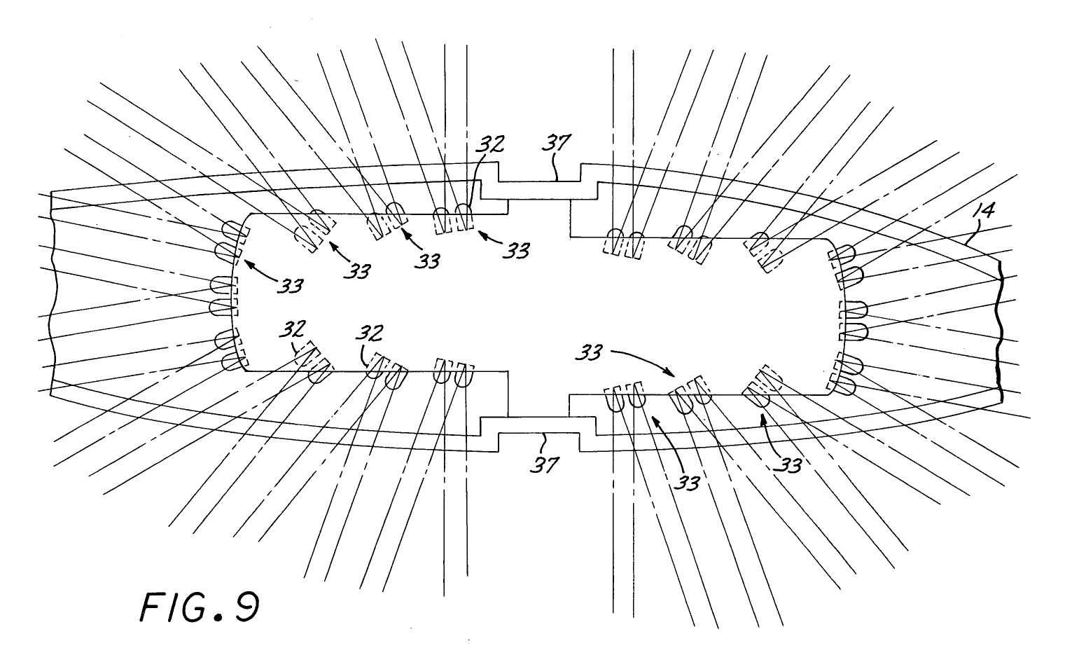

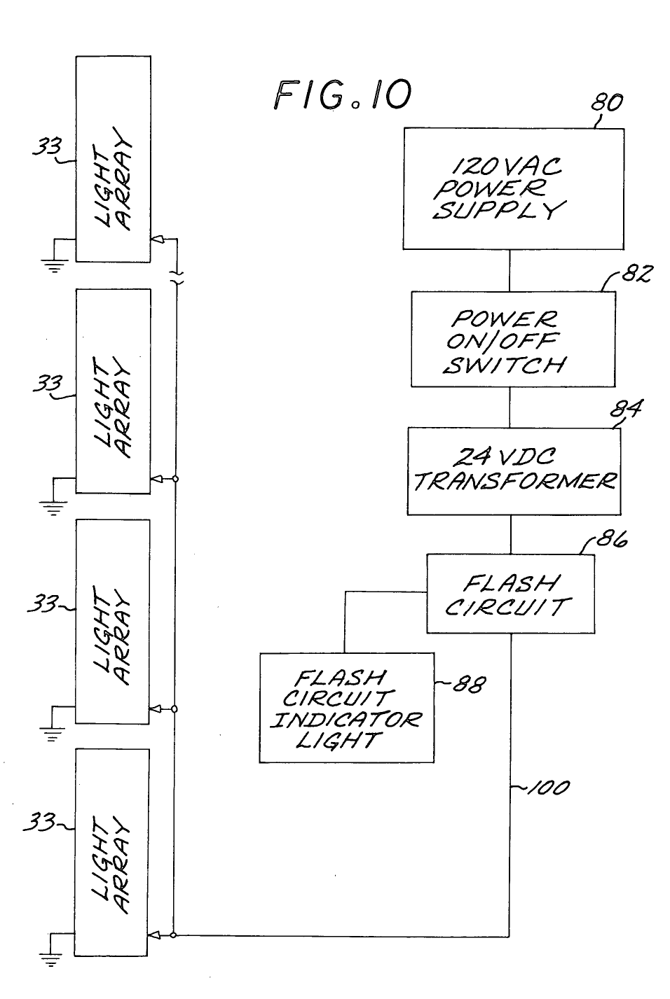

FIG. 3 is a sectional view along line 3-3 of FIG. 2 showing the interior portion of the wing tip 14 and the top plate (end cap) 30 of LED light framework, or structure, 31 of the present invention mounted to the interior wall surface of the wing 14. In the preferred embodiment LEDs 32 are arranged in eighteen arrays 33 in each wing and extend along the length of each wing 14 as shown in more detail in FIGS. 4 and 9. Fastener members 35 are utilized to fasten top plate 30 to the spar, or center dove tail support 44; fastener members 36 are installed after the light framework 31 is assembled to provide additional stability to the assembly.

Referring to FIG. 4, a sectional view of the interior portion of the wing 14 shows LED mounting core units 40 and 42, and spar 44 having a four dove tails formed therein. The LED arrays 33 are mounted to the cores 40 and 42 as illustrated and described in more detail in FIGS. 6-8. The two LEDs 32 are mounted to a lower printed circuit board 46 and a printed circuit board 48 is provided to secure LEDs 32 to LED core units 40 and 42. Printed circuit board 48 also provides a RFI banner and lightning protection. The LED PCBs 46 and 48 are aligned and then mounted to cores 40 and 42 and then connected to the main circuit (not shown). It should be noted that PCBs 46 and 48 preferably extend as a single, integral until along a portion of the length of wings 14. The resulting assembled cores 40 and 42 slide into the dove tails formed in spar 44, the spar 44 then sliding into the tip of wing 14 via guides, or channels, 50 provided in the wing tip. PCBs 46 mount the circuitry for the LEDs; PCBs 48 secure the LEDs against gravity force, provide for RFI and lightning protection, as noted hereinabove, and also insures that the LEDs are aligned properly. Preferably, each LED 32 has an illumination angle appropriate to the illumination specification required for the aviation lighting standards established in a given geographical region. In the preferred embodiment, each array comprises 1080 LEDs and the height of each array is approximately 18.50 inches. It should be noted that more or less LEDs can be used and the height of the array can be increased or decreased if required. Bars 22 are positioned in recesses 37 and secured thereto by fasteners 45.

FIG. 5 is a cross-section along line 5-5 of FIG. 3 showing the side of wing 14 and framework top plate 30 and bottom plate 52, wing supports 54 and 56, fastening members 26 and 45 and two LED arrays 33.

FIG. 6 illustrates one component of a LED light array 33 mounted to core unit 40. Layer 47 is an optional epoxy layer which further secures printed circuit boards 46 and 48, creating a rigid assembly (or lamination).

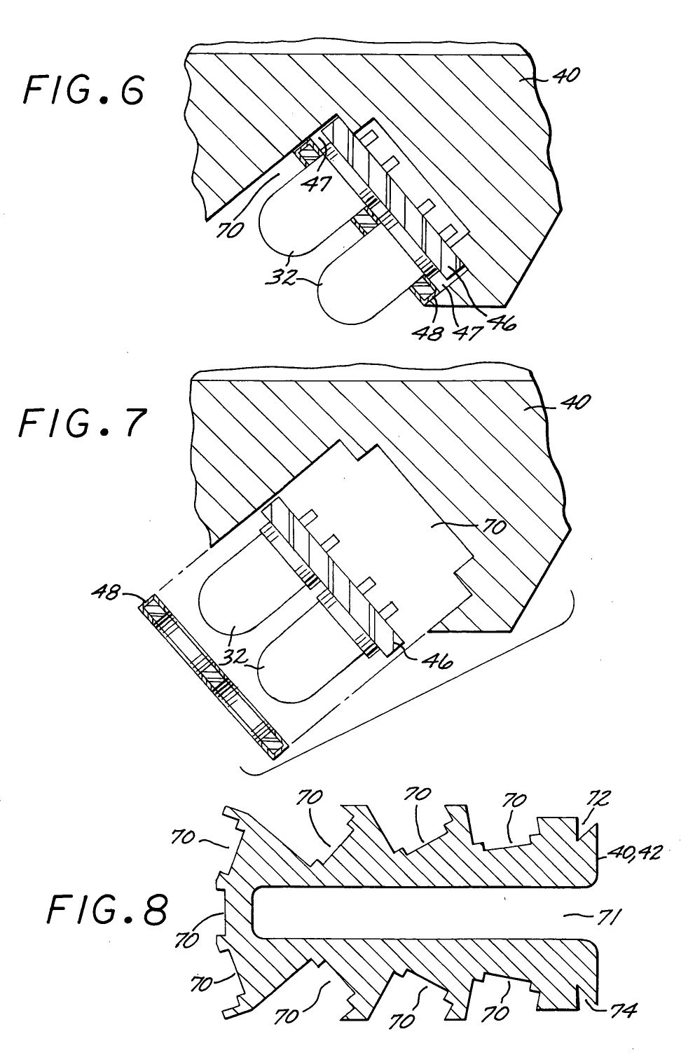

FIG. 7 is an exploded view of the LED mounting shown in FIG. 6.

FIG. 8 is a cross-section of mounting cores 40 and 42. Each core includes a plurality of receiving areas, or receptacles, 70 to receive the PCB's 46 and 48 (FIGS. 6 and 7) and includes indentations 72 and 74 for engaging the dove tails formed in spar 44. A hollow area 71 is provided to reduce weight while maintaining structural rigidity.

FIG. 9 illustrates the preferred arrangement of eighteen LED light arrays 33, after installation in the wing tip of wing 14, and the light pattern provided thereby. The pattern provided by the LED's is spread sufficiently to provide a 360° circumferential warning to approaching aircraft. The wing 14, as shown in the Figure, rotates clockwise.

FIG. 10 is a block diagram for a preferred circuit utilized to cause the LED light arrays 50 to flash in a controlled burst to provide the required intensity.

A 120 volt ac power supply 80 is coupled to on/off power switch 82, the switch being connected to 24 VDC transformer 84. The output from transformer 84 is coupled to flash circuit 86, the output of circuit 86 being coupled to flash circuit indicator light 88 and to light arrays 33. The actual circuit used is determined by each wing manufacturer. It should be noted that LED circuitry is integrated in the lower cap 52 and spar 44 and that the power supply 80 is provided by the wing manufacturer.

The present invention thus provides a windmill having the tips of its wings modified to include a plurality of LED arrays to provide a 360° circumferential light output pattern around the wing tip at an illumination angle appropriate to the lighting specifications of the regulatory body, such as the FAA, so that a warning signal is given to approaching aircraft.

The present invention additionally provides:
1. A complete internal structure which does not change the external wing configuration (the airfoil is not altered); and
2. A 360° circumferential light pattern around the wing tip providing a true beacon light (the prior art system illuminates into space, not around the wing tip), the “light pollution” thus being minimized while still providing a light intensity which complies with regulatory requirements.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. An illuminating structure positioned within the wing of a windmill, said wing coupled to a rotating hub and having a cavity with an internal surface comprising:
a first mounting structure positioned within said wing cavity adjacent the tip thereof;
a first member having a plurality of illuminating members mounted thereto and extending along a portion of said wing; said first member being coupled to said first mounting structure; and
means for holding said first mounting structure, said second holding means being secured to the internal surface of said cavity and having first and second ends.

2. The illuminating structure of claim 1 further including a second mounting structure positioned within said wing cavity adjacent the tip thereof, a second member having a plurality of illuminating members mounted thereto and extending along a portion of said wing.

3. The illuminating structure of claim 2 where said second member is coupled to said holding means.

4. The illuminating structure of claim 3 wherein said illuminating members mounted to said first marks comprise LEDs.

5. The illuminating structure of claim 4 wherein said illuminating members mounted to said second member comprise LEDs.

6. The illuminating structure of claim 5 wherein said LEDs, when energized, provide a substantially 360° circumferential illumination pattern around said wing tip.

7. The illuminating structure of claim 2 wherein recesses are formed in said first and second mounting structures.

8. The illuminating structure of claim 6 wherein said first and second members comprise a plurality of multi-layer strips adapted to receive a predetermined number of LEDs in a manner to provide said substantially 360° circumferential illumination pattern when said LEDs are energized.

9. The illuminating structure of claim 8 wherein said first and second mounting members have a plurality of receptacles for receiving said multi-layer strips are arranged such that said substantially 360° circumferential light pattern is provided when said LEDs are energized.

10. The illuminating structure of claim 9 wherein one end of said first and second mounting structures are shaped to slide into a recess formed on each side of said holding means.

11. The illuminating structure of claim 1 wherein first and second channels are formed in the internal surface of said wing and adapted to receive said first and second ends, respectively, of said holding means.

12. The illuminating structure of claim 8 wherein said LEDs are mounted to a first printed circuit board, a second printed circuit board being positioned over said first circuit board, the second printed circuit board providing a radio frequency barrier and lightning protection.
